(19) United States
(12) Patent Application Publication
(10) Pub. No.: US 2025/0070287 A1
(43) Pub. Date: Feb. 27, 2025

(54) PRESSURE SENSING CELL FOR ACCURATE PRESSURE SENSING IN A BATTERY PACK

(71) Applicant: IEE INTERNATIONAL ELECTRONICS & ENGINEERING S.A., Echternach (LU)

(72) Inventors: Arthur CRETIN, Luxembourg (LU); Patrick DI MARIO COLA, Serrouville (FR); Thierry GONIVA, Luxembourg (LU); Lukas WÜRTH, Arlon (BE)

(21) Appl. No.: 18/721,027

(22) PCT Filed: Dec. 12, 2022
(86) PCT No.: PCT/EP2022/085442

§ 371 Date: Jun. 17, 2024

(30) Foreign Application Priority Data
Dec. 15, 2021 (LU) LU501021
Feb. 1, 2022 (LU) LU501378

(51) Int. Cl. H01M 10/48; B60L 3/00; B60L 58/16; B60L 58/24; G01L 19/00; H01M 50/211

(52) U.S. Cl. CPC H01M 10/486; B60L 3/0046; B60L 58/16; B60L 58/24; G01L 19/0084; G01L 19/0092; H01M 10/482; H01M 50/211; H01M 2220/20

(57) ABSTRACT

A pressure sensing cell for use in a battery pack that has a plurality of linearly stacked battery cells. The pressure sensing cell includes an at least partially fluid-filled and fluid-proof flexible pouch container having a plurality of electric feedthroughs, at least one pressure-sensitive member having a plurality of electric pins, that is arranged within the flexible pouch container, and a plurality of electric lines that electrically connect the plurality of electric feedthroughs and the plurality of electric pins. A battery pack is provided that includes a plurality of linearly stacked battery cells and at least one such pressure sensing cell. A method for at least one of detecting upcoming thermal runaway, supporting the evaluating of a state of safety, and supporting the evaluating of a state of health of a battery pack having a plurality of linearly stacked battery cells employs at least one such pressure sensing cell.

### TECHNICAL FIELD

The invention relates to a pressure sensing cell for use in a battery pack comprising a plurality of linearly stacked battery cells, a battery pack comprising a plurality of linearly stacked battery cells and at least one such pressure sensing cell, and a method for at least one of detecting upcoming thermal runaway, supporting the evaluating of a state of safety and supporting the evaluating of a state of health of such a battery pack.

### BACKGROUND

Modern batteries are used in a wide range of technological fields. For example, batteries are currently used in electrical devices, in vehicles or large-scale industrial facilities. Regularly, several batteries, respectively battery cells, such as e.g. pouch cells, are arranged within a housing of a battery pack.

In view of present mobility-related technologies, such battery packs represent key elements for storing and providing energy for electrical vehicles (EV), hybrid electric vehicles (HEV), plug-in hybrid vehicles (PHEV) and new energy vehicles (NEV).

During its service life, a battery pack is not only exposed to demanding environmental impacts, such as e.g. heat, cold and humidity, but also to demanding reaction dynamics such as, for example, the frequency and number of charging and de-charging processes. These aspects have an influence on the total and remaining service life and condition of the battery pack. As a result, battery cells and battery packs are subject to aging and degradation processes, which may increase the occurrence of “swelling” or “gassing”.

“Gassing” may generally refer to a phenomenon caused by gas generation inside a battery (cell). Gassing may result from the decomposition of the electrolyte inside the battery and/or be caused by overheating and/or overcharging a battery. A gassing battery cell may swell, break or even explode. “Swelling” generally refers to a volume change of the battery (cell). The swelling may for example be caused by storage and removal processes of lithium ions in and/or on the electrode. Swelling may also be caused by gassing. Swelling leads to a mechanical deformation of the battery cell, which causes pressure forces in and/or on the enclosure of the battery cell and/or the battery pack. In order to compensate swelling, battery manufacturers usually use rigid structures such as metal or hard plastic housings which counter expansions of the housing. Furthermore, the battery manufacturers typically include elastic materials, such as foams, in the stack to absorb the swelling.

An expansion, respectively a displacement or dilatation caused by the occurrence of pressure forces during swelling, may correlate with the so-called “State of Health” (SOH) of a battery pack. “State of health” generally refers to the aging state of a battery pack, which thus represents a measure, respectively an indicator, of the battery pack ability to store and deliver electrical energy in comparison to a new battery pack. The dilatation is also used to determine and/or predict the end of life (EOL) of the battery pack. The EOL generally is used to determine a period in which the battery pack may be safely charged and discharged. The EOL may also be used, like the SOH, as an indicator for indicating the remaining operating time, respectively the remaining service life time, of the battery pack.

In order to enhance the security and reliability of the battery pack in its operation environment, a battery management system (BMS) is often used to determine or estimate the state of charge (SOC) of the respective battery cells of the battery pack as well as the SOH and the EOL. The “state of charge” generally refers to the available capacity which might be expressed or represented as a percentage of its predetermined capacity. In other words, SOC, EOL and SOH are indicators that are determinable by the BMS.

It is further possible to configure the BMS to measure and/or determine further parameters of the battery pack and/or the battery cells, such as e.g. the temperature values and/or the voltages of battery cells. The BMS may have also access to pre-determined and stored specific battery cell characteristic data and measurements, taken from a reference battery cell and/or a reference battery pack. Based on such data, the BMS may, for example, compare stored and/or measured values of a cell with the reference values in order to more precisely determine the different indicators. The BMS may further be configured to monitor the functioning of the respective cells as well as the charging and discharging processes. As a result, the BMS may identify defective cells and switch off such cells. In most cases, the cells have to be replaced when they have been identified as defective; typically, the entire module or pack is replaced.

The useful life, respectively the service life time or remaining operating time, of the battery may be limited by a maximum pressure applied on the mechanical enclosure, respectively the housing, of the battery pack. Usually, the value of the maximum bearable pressure is known by manufacturers. A pressure (force) exceeding the predetermined maximum bearable pressure may lead to a failure of the battery cell, the housing or the entire battery pack. For example, a pressure which is caused by a swelling of a battery cell and which exceeds the predetermined maximum bearable pressure value may result in a breach of the battery cell. For this reason, battery management systems may also be configured to detect swellings.

In order to detect a swelling, common battery management systems use algorithms or complex mechanical devices to perform estimations on the current condition, respectively state, of the battery cell and/or the battery pack. The use of such algorithms may be based or rely on more or less correct estimation(s) of the EOL indicator, the SOC indicator or the SOH indicator. Alternatively, in order to determine a state of the battery, the BMS can be subjected to test conditions within a laboratory or a test bench, for example. In this context, the battery pack is examined by means of or connected to complex mechanical measurement devices.

For example, US 2014/0107949 A1 describes a battery management system for use with a battery under test conditions. The system includes a container configured to hold the battery. The system also includes a stress/strain sensor. The container is configured to hold the battery in fixed relationship with respect to the stress/strain sensor. A processor is coupled to the stress/strain sensor, wherein the processor is configured to measure the stress/strain on the battery and determine the state of health (SOH) of the battery based on the measured stress/strain and previously stored SOH relationship data for the battery. The processor may be configured to determine a state of charge (SOC) of the battery based on the measured stress/strain, the SOH of the battery and previously stored SOC relationship data for the battery.

Further, DE 10 2012 209 271 A1 describes at least one battery cell with a cell housing and an electrode winding arranged inside the cell housing. The battery management system includes a battery condition detection. The electrode winding of the battery cell is at least partially covered by a pressure-sensitive film sensor. The battery state detection mechanism is designed to read in a measured value provided by the pressure-sensitive film sensor, or a variable derived from this measured value, and to use the measured value or variable as an evaluation parameter for determining the battery state. The battery state detection mechanism is configured to determine a swelling force from the swelling of the electrode winding due to the state of charge of the same, using the measured value provided by the pressure-sensitive film sensor or the derived variable. The swelling force is used for further determining the state of charge (SOC) or state of health (SOH) of the battery cell.

In battery packs with linearly stacked battery cells it is known in the art to use one or more compression pads stacked between adjacent battery cells to ensure a slight compression in a newly built condition, and further to allow for expansion and contraction during charging, discharging and aging. Typical values to be covered by the compression pads are a few % of the battery pack length over the battery pack lifetime. For the material used in such compression pads, a stress-strain curve showing a low compressive stress across a broad range of compressive strain is desirable. Further, the material should show an as low as possible compression set particularly at conditions of high relative humidity and temperatures in an upper region of the regular operating range of the battery pack. A known example for such a material is micro-cellular polyurethane foam.

### SUMMARY

It is therefore an object of the invention to provide a battery-compatible detection cell for use in a battery pack comprising a plurality of linearly stacked battery cells, in particular pouch cells, for reliably sensing a current compression load present in the battery pack in support of detecting upcoming thermal runaway and/or evaluating state of safety (SOS) and/or state of health (SOH) of the battery pack.

In one aspect of the present invention, the object is achieved by a pressure sensing cell for use in a battery pack comprising a plurality of linearly stacked battery cells. The pressure sensing cell comprises a flexible pouch container, at least one pressure-sensitive member and a plurality of electric lines. The flexible pouch container is at least partially fluid-filled and fluid-proof and has a plurality of electric feedthroughs. The at least one pressure-sensitive member comprises a plurality of electric pins and is arranged within the flexible pouch container. The plurality of electric lines connects the plurality of electric feedthroughs and the plurality of electric connections.

It is an insight of the present invention that the compression load applied to the flexible pouch container when installed in the battery pack is proportional to the forces present in the stacked battery cells and can be sensed by the at least one pressure-sensitive member arranged within the flexible pouch container.

As a rising compression load is one of the first symptoms of an upcoming thermal runaway of the battery pack, the proposed pressure sensing cell can enable an early detection of an occurrence of thermal runaway, and can support in taking measures for potential prevention by precise sensing of a current compression load. Further, the proposed pressure sensing cell provides the prerequisites for continuous monitoring of the compression load within the battery pack and thus can support in evaluating the state of health of the battery cells by applying one of well-known suitable evaluation methods.

Thermal runaway is known to be one of the most serious failure modes of a rechargeable traction battery. Details are, for instance, described in Koch, Sascha et al. “Fast Thermal Runaway Detection for Lithium-Ion Cells in Large Scale Traction Batteries.” (Batteries 2018, 4(2), 16; DOI: 10.3390/batteries4020016). Thermal runaway of single cells within a large-scale lithium-ion battery pack is a well-known risk that can lead to critical situations if no counter measures are taken in today's lithium-ion traction batteries for battery electric vehicles (BEVs), plug-in hybrid electric vehicles (PHEV) and hybrid electric vehicles (HEVs). Fast and reliable detection of faulty cells undergoing thermal runaway within the lithium-ion battery is therefore a key factor in battery designs for comprehensive passenger safety.

The pressure sensing cell is in particular advantageously employable in battery packs for automotive applications. The term “automotive”, as used in the present patent application, shall particularly be understood as being suitable for use in vehicles including passenger cars, trucks, semi-trailer trucks and buses.

It is further conceived that the proposed pressure sensing cell or cells can be used in addition to compression pads employed in conventional battery packs, as well as in replacement of such compression pads.

It will be appreciated that the flexible pouch container is preferably made of a suitable flexible film material which is sealed at respective border so as to from a fluid-proof pouch. An example of an appropriate material for the flexible pouch container is a sandwich laminate comprising aluminum and polyethylene (PE) and/or polypropylene (PP). Preferably, dimensions of the flexible pouch container in a virtual plane transverse to a stacking direction of the battery pack are adapted to respective dimensions of the battery cells. The flexible pouch container may in particular have similar dimensions than the battery cells or battery pouches. In this way, the complete cross-sectional area of the battery pack can be included in a sensing of the compression load, and any rise in compression load can be captured by the pressure sensing cell, as the compression load propagates evenly in the fluid of the flexible pouch container.

In preferred embodiments, the pressure sensing cell comprises a dielectric carrier member, which at least the electric lines of the plurality of electric lines are fixedly attached to. By that, a compact and mechanically stable solution can be provided for the electric lines of the pressure sensing cell, which can result in a high degree of operational reliability.

A similar benefit can be accomplished if the pressure sensing cell comprises a dielectric carrier member, which the at least one pressure-sensitive member is fixedly attached to. An especially mechanically stable and reliable configuration of the pressure sensing cell can be achieved if both the electric lines and the at least one pressure-sensitive member are fixedly attached to the same dielectric carrier member.

In preferred embodiments, the pressure sensing cell further includes at least one temperature sensor that is arranged within the flexible pouch container. Electric contacts of the at least one temperature sensor are electrically connected to the plurality of electric feedthroughs by the plurality of electric lines.

By providing, besides the current compression load in the battery pack, a current temperature that is present in the battery pack at the same time, further independent information can be used for detecting an upcoming thermal runaway of the battery pack and/or for evaluating the state of health or the state of safety of the battery pack in an improved manner.

Preferably, the at least one temperature sensor is arranged in a middle third with respect to the dimensions of the flexible pouch container in a virtual plane perpendicular to the stacking direction. In this way, a temperature that is sensed by the at least one temperature sensor can represent a battery stack temperature that is unaffected by boundary or geometry effects and can therefore be considered a characteristic battery stack temperature.

In preferred embodiments of the pressure sensing cell, the dielectric carrier member is made for the most part from a planar foil of plastic material that is selected from a group of plastic materials formed by polyethylene terephthalate (PET), polyimide (PI), polyetherimide (PEI), polyethylene naphthalate (PEN), polyoxymethylene (POM), polyamide (PA), polyphthalamide (PPA), polyether ether ketone (PEEK), and combinations of at least two of these plastic materials, and the electric lines of the plurality of electric lines comprise cured electrically conductive ink.

The term “for the most part”, as used in the present application, shall particularly be understood as equal to or more than 70%, more preferably more than 80%, and, most preferably, more than 90% in volume, and shall encompass a part of 100%, i.e. the dielectric carrier member is completely made from the selected plastic material.

These plastic materials can allow for easy manufacturing, and durable, cost-efficient dielectric carrier members of low manufacturing tolerances can be provided in this way. The use of a planar foil of plastic material can allow for an assembly with an especially compact design in particular in a direction perpendicular to the surface of dielectric carrier member.

By making the electric lines of the plurality of electric lines from electrically conductive ink, an application of high-precision manufacturing methods such as screen printing and ink jet printing is facilitated, resulting in low production tolerances and little material waste.

In preferred embodiments of the pressure sensing cell, the dielectric carrier member is made for the most part from glass-reinforced epoxy laminate material, and the electric lines of the plurality of electric lines are formed by etched copper tracks. In this way, a dielectric carrier member of low weight and high mechanical stability can be provided and can be made using the well-known methods for producing printed circuit boards.

In another aspect of the present invention, a battery pack is provided that comprises a plurality of linearly stacked battery cells, and at least one potential embodiment of the pressure sensing cell disclosed herein. In the battery pack, the flexible pouch container of the pressure sensing cell is arranged in mechanical contact to at least one battery cell. The benefits described in context with the pressure sensing cell applying to the proposed battery pack to the full extent.

In particular, the battery cells of the battery pack may be designed as pouch cells, as is known in the art.

Preferably, an ultimate tensile strength of the material of the flexible pouch container of the at least one pressure sensing cell exceeds an ultimate tensile strength of the pouch material. In this way an operability of the pressure sensing cell can be ensured at least up to an occurring failure at one of the battery cells of the battery pack.

In yet another aspect of the present invention, a method for at least one of detecting upcoming thermal runaway, supporting the evaluating of a state of safety and supporting the evaluating of a state of health of a battery pack is provided, wherein the battery pack comprises a plurality of linearly stacked battery cells.

The proposed method comprises at least the following steps:
providing at least one potential embodiment of the pressure sensing cell disclosed herein,
arranging the at least one pressure sensing cell in the battery pack such that the flexible pouch container is arranged in mechanical contact to at least one of the battery cells,
providing electric connections from the plurality of electric feedthroughs to at least one electric receiving circuitry,
receiving, by the at least one electric receiving circuitry, electric signals representing a current compression load or representing a current compression load and a current battery cell temperature, and
evaluating, from the electric signals received by the electric receiving circuitry, at least one of a status of an upcoming thermal runaway, a state of safety and a state of health of the battery pack.

As a rising compression load is one of the first symptoms of an upcoming thermal runaway of the battery pack, the proposed method can ensure an early detection of an occurrence of thermal runaway, and can provide support in taking measures for potential prevention by the precise sensing of a current compression load. Further, the proposed method can provide continuous monitoring of the compression load within the battery pack and thus can achieve evaluation of the state of safety and/or the state of health of the battery cells by applying one of well-known suitable evaluation methods.

These and other aspects of the invention will be apparent from and elucidated with reference to the embodiments described hereinafter.

It shall be pointed out that the features and measures detailed individually in the preceding description can be combined with one another in any technically meaningful manner and show further embodiments of the invention. The description characterizes and specifies embodiments of the invention in particular in connection with the figures.

### BRIEF DESCRIPTION OF THE DRAWINGS

Further details and advantages of the present invention will be apparent from the following detailed description of not limiting embodiments with reference to the attached drawing, wherein:

FIG. 1 schematically shows an embodiment of a battery pack in accordance with the invention, installed in a battery electric vehicle, in a perspective partial ghosted illustration,

FIG. 2 is a schematic perspective partial view on one of the battery packs pursuant to FIG. 1, including an explosion view of an embodiment of a pressure sensing cell in accordance with the invention stacked between battery cells of the battery pack,

FIG. 3 is a schematic illustration of an embodiment of a pressure-sensitive member fixedly attached to an alternative embodiment of a dielectric carrier member, forming part of the pressure sensing cell pursuant to FIG. 2, in a front view as seen in a stacking direction,

FIG. 4 is a schematic illustration of the pressure sensing cell pursuant to FIG. 2, in a side sectional view,

FIG. 5 is a schematic illustration of the pressure-sensitive cell pursuant to FIG. 2 in a front sectional view as seen in the stacking direction,

FIG. 6 is a schematic illustration of an embodiment of a pressure sensing cell with the pressure sensor located in a secondary container, and

FIG. 7 is a flow chart of a method of at least one of detecting upcoming thermal runaway, supporting the evaluating of a state of safety and supporting the evaluating of a state of health of the battery packs pursuant to FIG. 1, employing the pressure sensing cell pursuant to FIG. 2.

In the different figures, the same parts are always provided with the same reference symbols or numerals, respectively. Thus, they are usually only described once.

### DETAILED DESCRIPTION

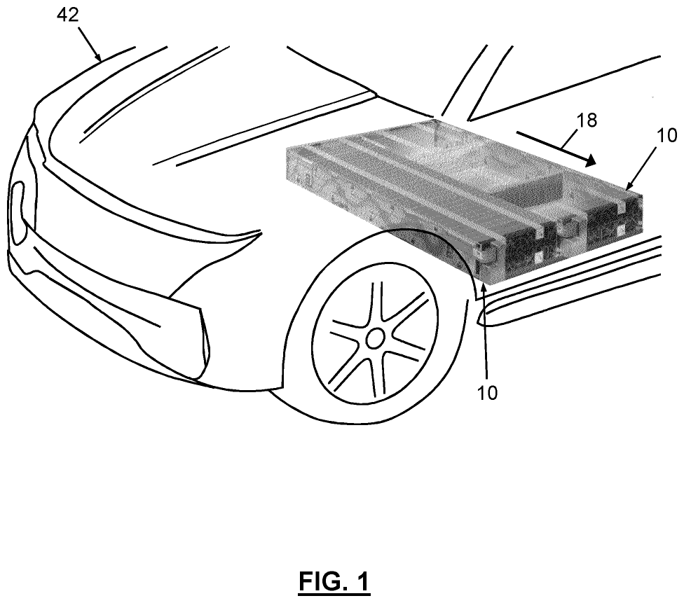

FIG. 1 schematically shows a battery pack 10 containing two modules in accordance with an embodiment of the invention, installed in a battery electric vehicle 42, in a perspective partial ghosted illustration. In this specific embodiment, the vehicle 42 may be designed as a passenger car, but in other embodiments the plurality of battery packs 10 may be installed in a truck or a bus.

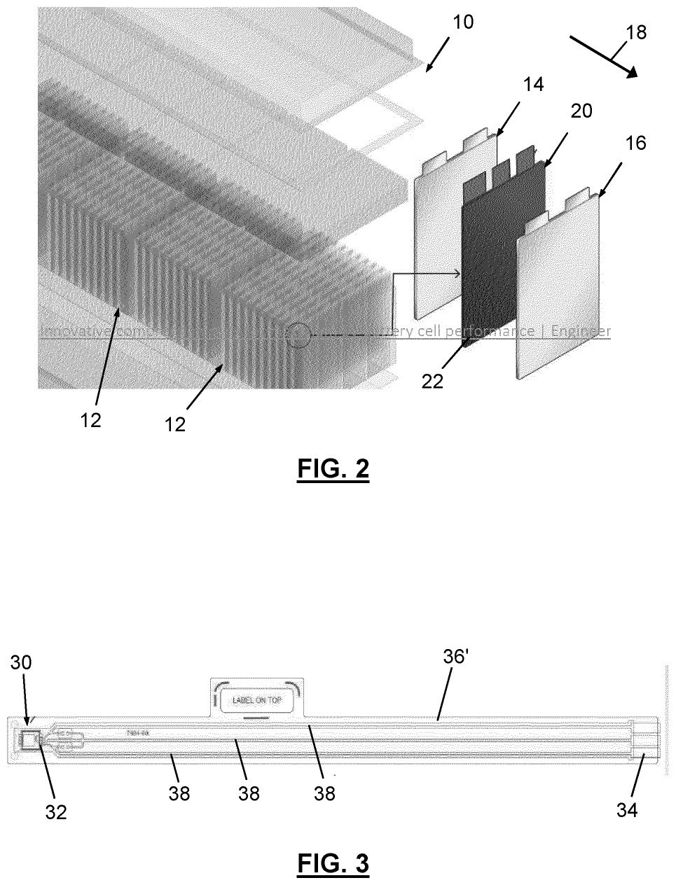

FIG. 2 is a schematic perspective partial view on one of the battery packs 10 pursuant to FIG. 1, which is shown exemplarily for all of the battery packs 10. The battery pack 10 comprises a plurality of battery cells 12, 14, 16, which are linearly stacked in a stacking direction 18, and which in particular may be formed by pouch cells. In this specific embodiment, the stacking direction 18 is arranged parallel to the width direction of the vehicle 42.

The battery pack 10 further comprises a plurality of pressure sensing cells 20. An embodiment of one of the pressure sensing cells 20 for use in the battery pack 10 is exemplarily shown in FIG. 2 in an explosion view. The pressure sensing cell 20 is stacked between two battery cells 14, 16 of the battery pack 10.

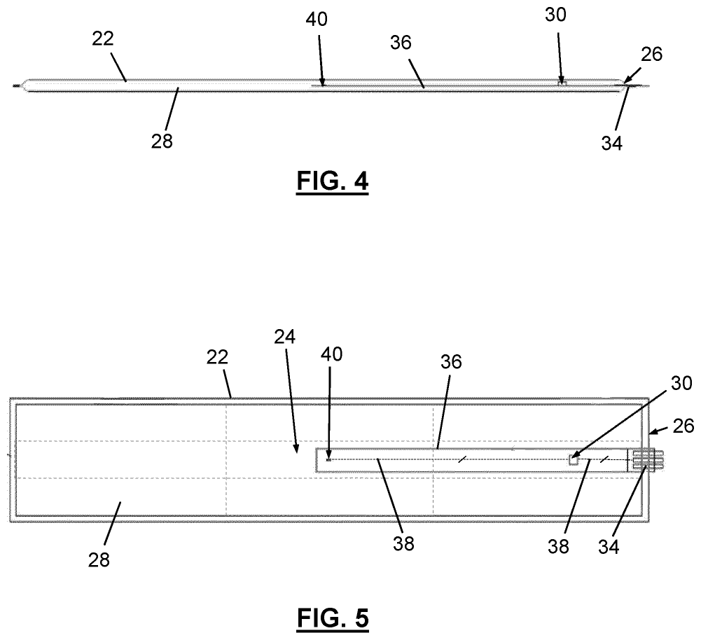

FIG. 4 is a schematic illustration of the pressure sensing cell 20 pursuant to FIG. 2 in a sectional side view. FIG. 5 is a schematic illustration of the pressure-sensitive cell 20 pursuant to FIG. 2 in a sectional front view as seen in the stacking direction 18.

The pressure sensing cell 20 comprises a fluid-proof flexible pouch container 22 that is substantially formed as a hollow rectangular block. An example of an appropriate material for the flexible pouch container 22 is a sandwich laminate comprising aluminum and polyethylene (PE) and/or polypropylene (PP). As indicated in FIG. 2, dimensions of the flexible pouch container 22 in a virtual plane transverse to the stacking direction 18 of the battery pack 10 are adapted to respective dimensions of the battery cells 12, 14, 16. Depending on the specific purpose, the flexible pouch container 22 may be partially filled by a fluid 28 (FIG. 4) such as a gas, for example air, or a gel. Another portion of the volume of the flexible pouch container 22 may be taken by a foam, for instance a micro-cellular polyurethane foam.

The pressure sensing cell 20 further includes a pressure-sensitive member 30, which comprises a plurality of electric pins 32. The electric pins 32 are shown in FIG. 3 only, which is a schematic illustration of the pressure-sensitive member 30 fixedly attached to an alternative embodiment of a dielectric carrier member 36′. The pressure-sensitive member 30 may be formed by an IC-based capacitive sensor device with micromachined features or by a piezo-resistive sensor. Such sensors are commercially available these days. They are particularly configured for automotive applications, and are well known in the art. Some of these sensors convert an absolute pressure into an analog output signal provided at its plurality of electric pins 32. The pressure-sensitive member 30 is arranged within the flexible pouch container 22. Due to the fluid-filling of the flexible pouch container 22, any force exerted on the flexible pouch container 22 from the outside is transmitted to the pressure-sensitive member 30.

The fluid-proof flexible pouch container 22 is equipped with a plurality of electric feedthroughs 34, which are located at a container side 26 (FIG. 5). The pressure sensing cell 20 comprises a dielectric carrier member 36 and a plurality of electric lines 38.

In this specific embodiment (FIGS. 4 and 5), the dielectric carrier member 36 is made for the most part from a planar foil of plastic material, for instance polyimide (PI), which may have a thickness of about 50 μm to provide mechanical strength as well as sufficient flexibility. The electric lines 38 of the plurality of electric lines 38 of the pressure sensing cell 20 are fixedly attached to the dielectric carrier member 36, and may be produced by dispensing electrically conductive ink, for instance by screen printing or ink jet printing, onto the dielectric carrier member 36 and then applying a curing procedure.

In alternative embodiments (not shown) for applications with different requirements, the dielectric carrier member 36 may be made for the most part from glass-reinforced epoxy laminate material, and the electric lines 38 of the plurality of electric lines 38 may be formed by etched copper tracks.

The pressure-sensitive member 30 is fixedly attached to the dielectric carrier member 36 by connecting the electric pins 32 to the plurality of electric lines 38, for instance by soldering. It will be noted that the IC may also be connected by means of a “bonding” technique using an anisotropic conductive adhesive. In addition, an adhesive may be applied to attach the pressure-sensitive member 30 to the dielectric carrier member 36. At an end facing away from the pressure-sensitive member 30, the electric lines 38 of the plurality of electric lines 38 are electrically connected to the plurality of electric feedthroughs 34.

With reference to FIG. 2, the pressure sensing cell 20 is stacked between the two battery cells 14, 16 of the battery pack 10 such that the flexible pouch container 22 is arranged in mechanical contact to both the battery cells 14, 16. An ultimate tensile strength of the material of the flexible pouch container 22 of the pressure sensing cell 20 exceeds an ultimate tensile strength of the pouch material of the battery cells 12, 14, 16, for instance by choosing a larger material thickness. It will be appreciated that, further to the strength of the material of the flexible pouch container, the sealing joint of the flexible pouch container 22 plays an important factor. Indeed, the seal has to be appropriately configured in order to withstand the pressure levels for which the flexible pouch container 22 is specified.

The dielectric carrier member 36 extends from the container side 26 into a center region 24 of the flexible pouch container 22, which is indicated by dashed lines in FIG. 5. The pressure sensing cell 20 is further equipped with a temperature sensor 40, which for instance may be formed by an NTC (negative temperature coefficient) temperature sensor. The temperature sensor 40 is fixedly attached to an end of the dielectric carrier member 36 that faces away from the electric feedthroughs 34. Electric contacts of the temperature sensor 40 are electrically connected to feedthroughs 34 of the plurality of electric feedthroughs 34 by electric lines 38 of the plurality of electric lines 38.

The temperature sensor 40 is thus arranged within the flexible pouch container 22, and, more specific, is arranged in the center region 24 of the flexible pouch container 22, which can be defined by a middle third with respect to the dimensions of the flexible pouch container 22 in a virtual plane perpendicular to the stacking direction 18, so as to capture a temperature that can be considered a characteristic battery pack temperature. In FIG. 5, the virtual plane coincides with the drawing plane.

As is illustrated in FIG. 2, the pressure sensing cell 20 may be stacked between two battery cells 14, 16 of the battery pack 10. In this embodiment, pressure sensing cell 20 comprises a fluid-proof flexible pouch container 22 arranged between the two battery cells and a pressure-sensitive member 30 arranged inside the fluid-proof flexible pouch container 22 in a location situated between the two battery cells 14, 16. While this embodiment allows for a compact construction outside of the battery cell area, it is clear that such an embodiment requires a thicker flexible pouch container 22 or pouch to achieve a good pressure ratio between uncompressed and compressed state.

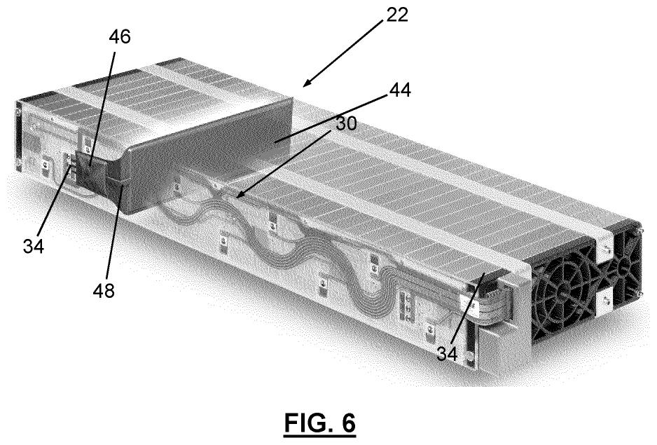

It will however be appreciated that it is not required that the pressure-sensitive member 30, i.e. the IC based sensor, is arranged geometrically in the plane between two adjacent battery cells. In fact, in a possible embodiment, schematically represented in FIG. 6, the fluid-proof flexible pouch container 22 may comprise a main pouch 44 and a secondary pouch 46, which are fluidly connected via a connection channel 48. In such an embodiment, the main pouch 44 of the flexible pouch container 22 is to be arranged in the space between the battery cells, while the secondary pouch 46 may be arranged outside of the battery cells, e.g. on a lateral side of the battery pack. The pressure-sensitive member 30, i.e. the IC based sensor, is preferably arranged in the secondary pouch 46, which is in fluid connection with the main pouch 44. Due to the fluid connection between the main pouch 44 and the secondary pouch 46, a pressure increase within the flexible pouch container 22 may be reliably detected by means of the pressure-sensitive member 30 arranged inside of the secondary pouch. It will be appreciated that in this embodiment because the IC based sensor is located outside of the space between the battery cells which allows for a main pouch 44 with reduced thickness.

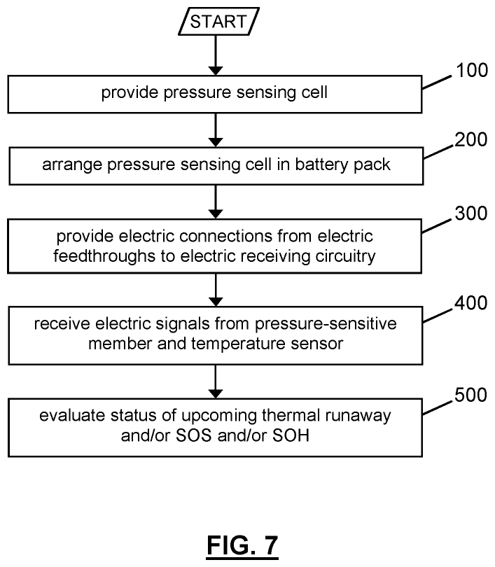

In the following, an embodiment of a method for at least one of detecting upcoming thermal runaway, supporting the evaluating of a state of safety and supporting the evaluating of a state of health of a battery pack 10 comprising a plurality of linearly stacked battery cells 12, 14, 16 using the pressure sensing cell 20 pursuant to FIG. 5 will be described with reference to FIG. 7, which shows a flow chart of a method.

With reference to FIGS. 2 and 7, in a step 100 of the method, the pressure sensing cell 20 is provided and arranged in the battery pack 10 in another step 200 such that the flexible pouch container is in mechanical contact to two of the battery cells 14, 16 of the battery pack 10.

Then, electric connections from the plurality of electric feedthroughs 34 to an electric receiving circuitry (not shown) are provided in another step 300. For instance, the electric receiving circuitry may form part of a battery management system or an electronic control unit of the vehicle 42. In another step 400 of the method, the electric receiving circuitry receives electric signals from the pressure-sensitive member 30 that represent a current compression load and electric signals from the temperature sensor 40 that represent a current battery cell temperature.

In another step 500, at least one of a status of an upcoming thermal runaway, a state of safety (SOS) and a state of health (SOH) of the battery pack 10 is evaluated, using the electric signals received by the electric receiving circuitry as evaluation parameters.

It is pointed out herewith that the figures in this application in general cannot be regarded as drawings to scale except for features explicitly described otherwise.

While embodiments of the invention have been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. A pressure sensing cell for use in a battery pack comprising a plurality of linearly stacked battery cells, wherein the pressure sensing cell comprises:
an at least partially fluid-filled and fluid-proof flexible pouch container having a plurality of electric feedthroughs,
at least one pressure-sensitive member, comprising a plurality of electric pins, that is arranged within the flexible pouch container, and
a plurality of electric lines that electrically connect the plurality of electric feedthroughs and the plurality of electric pins.

2. The pressure sensing cell as claimed in claim 1, wherein dimensions of the flexible pouch container in a virtual plane transverse to a stacking direction of the battery pack are adapted to respective dimensions of the battery cells.

3. The pressure sensing cell as claimed in claim 1, comprising a dielectric carrier member, which at least the electric lines of the plurality of electric lines are fixedly attached to.

4. The pressure sensing cell as claimed in claim 1, further comprising a dielectric carrier member, which the at least one pressure-sensitive member is fixedly attached to.

5. The pressure sensing cell as claimed in claim 1, further comprising at least one temperature sensor that is arranged within the flexible pouch container, and whose electric contacts are electrically connected to the plurality of electric feedthroughs by the plurality of electric lines.

6. The pressure sensing cell as claimed in claim 5, wherein the at least one temperature sensor is arranged in a middle third with respect to the dimensions of the flexible pouch container in a virtual plane perpendicular to the stacking direction.

7. The pressure sensing cell as claimed in claim 3, wherein;
the dielectric carrier member is made for the most part from a planar foil of plastic material that is selected from a group of plastic materials formed by polyethylene terephthalate PET, polyimide PI, polyetherimide PEI, polyethylene naphthalate PEN, polyoxymethylene POM, polyamide PA, polyphthalamide PPA, polyether ether ketone PEEK, and combinations of at least two of these plastic materials, and
the electric lines of the plurality of electric lines comprise cured electrically conductive ink.

8. The pressure sensing cell as claimed in claim 3, wherein the dielectric carrier member is made for the most part from glass-reinforced epoxy laminate material, and the electric lines of the plurality of electric lines are formed by etched copper tracks.

9. The pressure sensing cell as claimed in claim 1, wherein the fluid-proof flexible pouch container comprises a main pouch and a secondary pouch, which are fluidly connected via a connection channel, wherein in operation, the main pouch of the flexible pouch container is arranged between adjacent battery cells, while the secondary pouch is arranged outside of the battery cells, and wherein the least one pressure-sensitive member is preferably arranged in the secondary pouch.

10. A battery pack, comprising a plurality of linearly stacked battery cells, and at least one pressure sensing cell as claimed in claim 1, wherein the flexible pouch container is arranged in mechanical contact to at least one battery cell, wherein an ultimate tensile strength of the material of the flexible pouch container of the at least one pressure sensing cell exceeds an ultimate tensile strength of a pouch material of the battery cells.

11. A method for at least one of detecting upcoming thermal runaway, supporting the evaluating of a state of safety, and supporting the evaluating of a state of health of a battery pack comprising a plurality of linearly stacked battery cells, wherein the method comprising at least the following steps:
providing at least one pressure sensing cell as claimed in claim 1,
arranging the at least one pressure sensing cell in the battery pack such that the flexible pouch container is arranged in mechanical contact to at least one of the battery cells,
providing electric connections from the plurality of electric feedthroughs to at least one electric receiving circuitry,
receiving, by the at least one electric receiving circuitry, electric signals representing a current compression load or representing a current compression load and a current battery cell temperature, and
evaluating, from the electric signals received by the electric receiving circuitry, at least one of a status of an upcoming thermal runaway, a state of safety and a state of health of the battery pack.
